(19) United States
(12) Patent Application Publication
(10) Pub. No.: US 2023/0121357 A1
(43) Pub. Date: Apr. 20, 2023

(54) VAPING DEVICE

(71) Applicant: Next Level Ventures LLC, Seattle, WA (US)

(72) Inventor: Yifeng Deng, Shenzhen (CN)

(21) Appl. No.: 17/967,330

(22) Filed: Oct. 17, 2022

(30) Foreign Application Priority Data
Oct. 17, 2021 (CN) 202122492525.X

(51) Int. Cl. A24F 40/46; A24F 40/10; A24F 40/42; A24F 7/00; H05B 3/48; H05B 3/06

(52) U.S. Cl. CPC A24F 40/46; A24F 40/10; A24F 40/42; A24F 7/00; H05B 3/48; H05B 3/06

(57) ABSTRACT

A ceramic core has a hollow interior with a first, inner diameter. A coil with a second diameter is embedded in the ceramic core. At least a portion of the second diameter is smaller than the first, inner diameter of the ceramic core to expose at least a portion of the coil to the hollow interior of the ceramic core. The coil may be inlaid and fixed on the inner wall of the hollow interior, one end of the coil is fixedly connected to the first pin, the first pin embedded inside the ceramic core. The other end of the coil is fixedly connected to the second pin, the second pin embedded inside the ceramic core. The inner diameter of the coil is d, the inner diameter of the hollow interior is D, d is smaller than D, the wire diameter of the coil is xd, and xd cuts D.

### PRIORITY CLAIM

The present application claims priority to Chinese utility application no. 202122492525.X, filed Oct. 17, 2021, which is hereby incorporated herein in its entirety.

### TECHNICAL FIELD

The present disclosure relates generally to devices for vaping and methods of manufacturing such devices, including a ceramic heating core for e-cigarette atomizer.

### BACKGROUND

E-vaping devices, also referred to herein as vaping devices may be used for portable vaping. An e-vaping device may vaporize a pre-vapor formulation, such as an oil that may or may not contain one or more cannabinoids, to form a vapor. The e-vaping device may include a reservoir that holds a pre-vapor formulation and a heating element that vaporizes the pre-vapor formulation by applying heat to at least a portion of the pre-vapor formulation. E-vaping devices are often sold and shipped directly to local oil manufacturers, and then filled with a pre-vapor formulation, and capped by the local oil manufacturers.

The atomizer is an important part of a vaping device. Many existing ceramic heating cores have wire coils buried inside the ceramic core.

### SUMMARY OF DISCLOSURE

According to the present disclosure, a vaping system comprises a tank with a reservoir for holding a liquid to be vaporized, the tank having a proximal end for connection to a mouthpiece and a distal end for connection to a cartridge base. An atomizer housing within the tank comprises a distal base portion for receiving the liquid to be vaporized, a heating element, and a central lumen for a vapor to be drawn proximally, the central lumen extending from a distal end to a proximal end. A mouthpiece with an external wall and an interior guide lumen for receiving vapor from the proximal end of the central lumen is connectable to the proximal end of the central lumen and the tank.

In some embodiments, the heating element comprises a ceramic core having a hollow interior with a first, inner diameter and a coil embedded in the ceramic core, the coil having a second diameter, and wherein at least a portion of the second diameter is smaller than the first, inner diameter of the ceramic core to expose the coil to the hollow interior of the ceramic core.

In some embodiments, a heating element for a vaping device comprises: a ceramic core having a hollow interior with a first, inner diameter; a coil embedded in the ceramic core, the coil having a second diameter; and wherein at least a portion of the second diameter is smaller than the first, inner diameter of the ceramic core to expose at least a portion of the coil to the hollow interior of the ceramic core.

In some configurations, the coil comprises a proximal winding, a distal winding, and a plurality of medial windings between the proximal winding and the distal winding.

In some configurations, the coil comprises a proximal winding that is at least partially exposed to the hollow interior of the ceramic core.

In some embodiments, the distal winding is embedded in the ceramic core.

In some embodiments, the distal winding is at least partially exposed to the hollow interior of the ceramic core and the proximal winding is embedded in the ceramic core. The shape of the coil may be a generally frustoconical shape.

A ceramic heating core for a vaping device, comprising a ceramic core, a hollow interior, a coil, a first pin and a second pin, wherein the hollow interior is opened inside the ceramic core, and the coil being inlaid and fixed on an inner wall of the hollow interior.

A ceramic heating core for a vaping device, wherein one end of the coil is fixedly connected to the first pin, and the first pin being inlaid inside the ceramic core.

A ceramic heating core for a vaping device, wherein the other end of the coil is fixedly connected to the second pin, and the second pin being inlaid inside the ceramic core. The coil may be in the shape of a spring. In some embodiments, the coil is in the shape of a spring. In some embodiments, the ceramic heating core has an inner diameter of the coil d, an inner diameter of the hollow interior D, d being smaller than D, with a wire diameter of the coil being xd, and xd cutting D.

In some embodiments, one end of the coil is fixedly connected to the first pin, and the first pin is inlaid inside the ceramic core. In some embodiments, the other end of the coil is fixedly connected to the second pin, and the second pin is inlaid inside the ceramic core.

In some embodiments, the appearance of the coil is in the shape of a spring.

According to another aspect, the inner diameter of the coil is d, the inner diameter of the hollow interior is D, d is smaller than D, the wire diameter of the coil is xd, and xd cuts D.

### BRIEF DESCRIPTION OF DRAWINGS

The drawings are illustrative and not limiting of the scope of the invention which is defined by the appended claims. Not every element of the disclosure can be clearly displayed in a single drawing, and as such not every drawing shows each element of the disclosure. The components in the drawings are not necessarily to scale relative to each other. Like reference numerals designate corresponding parts throughout the several views.

FIG. 1 is a perspective view of a vaping device.

FIG. 2 is an exploded view of the device of FIG. 1.

FIG. 3 is a front, cross-sectional view of a vaping device.

FIG. 4 is a front, cross-sectional enlarged view of the area B of the vaping device shown in FIG. 3.

FIG. 5 is a perspective view of a heating element.

FIG. 6 is a perspective, partial cross-sectional view of the heating element of FIG. 5.

FIG. 7 is a cross-sectional view of the heating element of FIG. 5.

FIG. 8 is a cross-sectional enlarged view of the area A of the heating element of FIG. 7.

FIG. 9 is a perspective view of a coil used in a heating element.

FIG. 10 is a top view of the coil of FIG. 9.

FIG. 11 is a cross-sectional view of another embodiment of a heating element.

FIG. 12 is a cross-sectional view of another embodiment of a heating element.

FIG. 13 is a cross-sectional view of another embodiment of a heating element.

FIG. 14 is a cross-sectional view of another embodiment of a heating element.

### DETAILED DESCRIPTION

The present disclosure relates generally to a system and device for vaping. Certain components of the vaping system described herein will be described as being coupled or connected to one another and such connections and couplings may be achieved in any suitable manner. Additionally, such components may be integrated with one another or distributed in any suitable fashion. As used herein, the vaping system may be described as having parts or portions that are more proximal and parts or portions which are more distal. This is relative to the distance from a user's mouth with the vaping system is in use. For example, the mouthpiece of the vaping system will be more proximal, or on a proximal end of the vaping system. In one configuration, a portion or feature of the system which is towards the proximal end is closer to the proximal end than the distal end. Similarly, in an exemplary configuration, a portion or feature of the system which is towards the distal end is closer to the distal end than the proximal end.

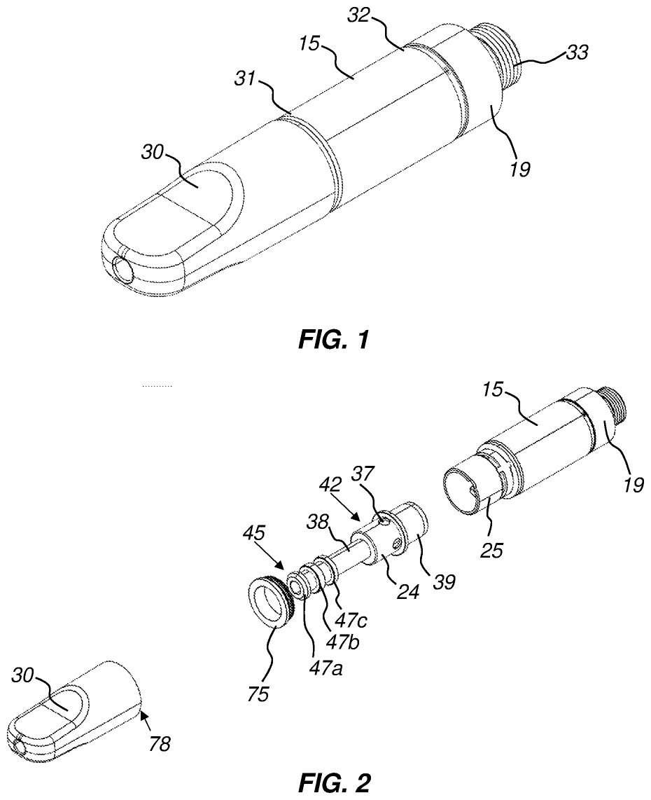

This disclosure generally relates to systems and methods for improved vaping systems. According to one aspect, an vaping system 10 (FIGS. 1-2) generally includes: a cartridge tank 15 or body with an interior reservoir to be filled with oil or another liquid for vaping; a cartridge base 19 for attachment to a distal end of the tank 15, which may hold an atomizer housing 24 that includes an atomizer or heating element for heating oil to create vapor, the atomizer housing in connection with a central lumen 38; a locking sheath 25 for connecting the cartridge tank 15 to the mouthpiece; and a mouthpiece 30 for attachment to a proximal end of the tank 15 and sealing the tank 15 closed.

The tank 15 has a proximal end 31 for connection to the mouthpiece 30 and a distal end 32 for connection to the cartridge base 19. The base 19 may include a means for connection to a battery to provide power to the heating element located within the atomizer housing 24 (shown, by way of example, as threaded distal projection 33 in FIG. 1).

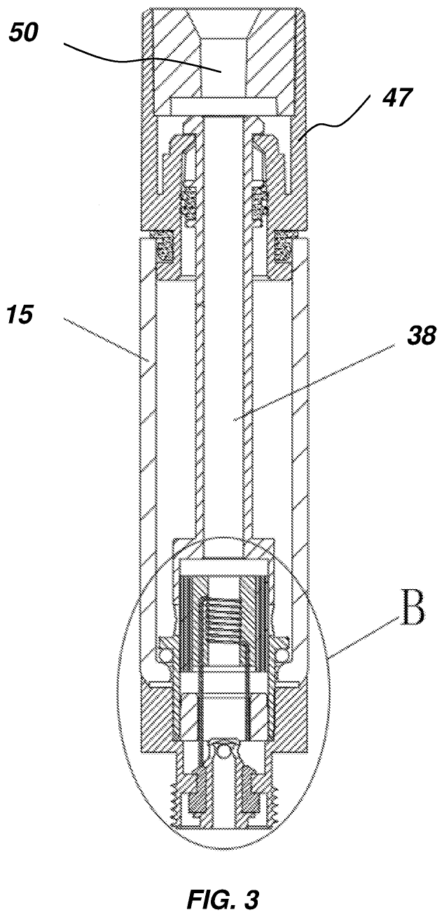

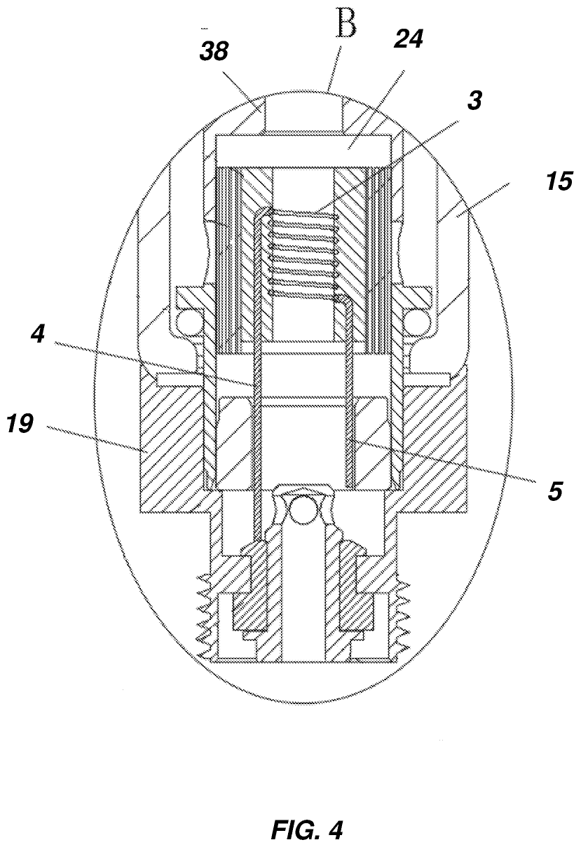

Holes 37 in the distal base portion 39 of the atomizer housing 24 allow oil from the reservoir of the tank 15 to enter the atomizer housing 24, contact one or more heating elements, and be heated into vapor. As the oil is vaporized, it travels from the atomizer housing upward through the central lumen 38, from the distal end 42 of the central lumen 38 to the proximal end 45 of the central lumen 38 to the mouthpiece 30 to be inhaled by the user. In a configuration shown in FIG. 3, the mouthpiece 30 includes an external wall and an interior guide lumen 50. The interior guide lumen 50 is in communication with the central lumen 38 for receiving vapor from the proximal end of the central lumen 38 to the mouthpiece 30. The vaping system 10 may include one or more gaskets or seals 75 between the mouthpiece 30 and the tank 15 to ensure the oil or other pre-vapor formulation does not leak out the mouthpiece 30.

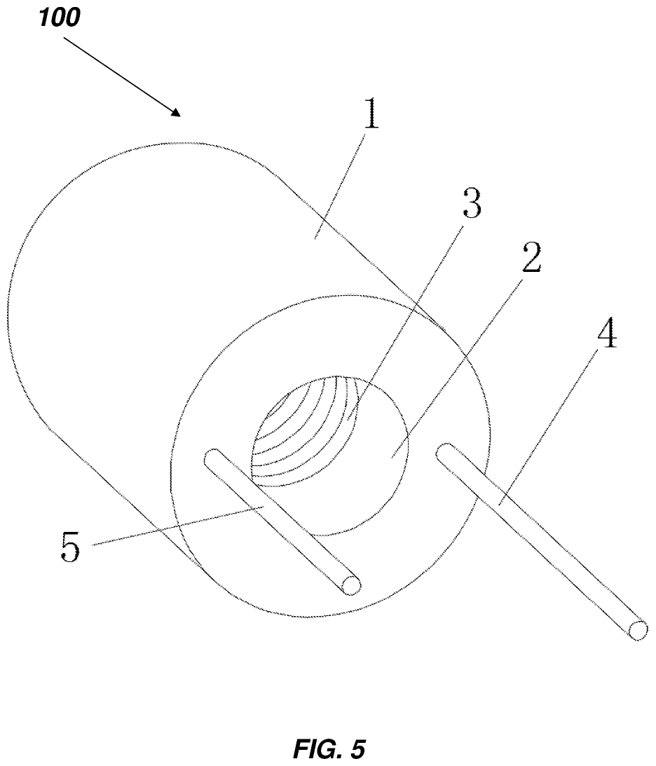

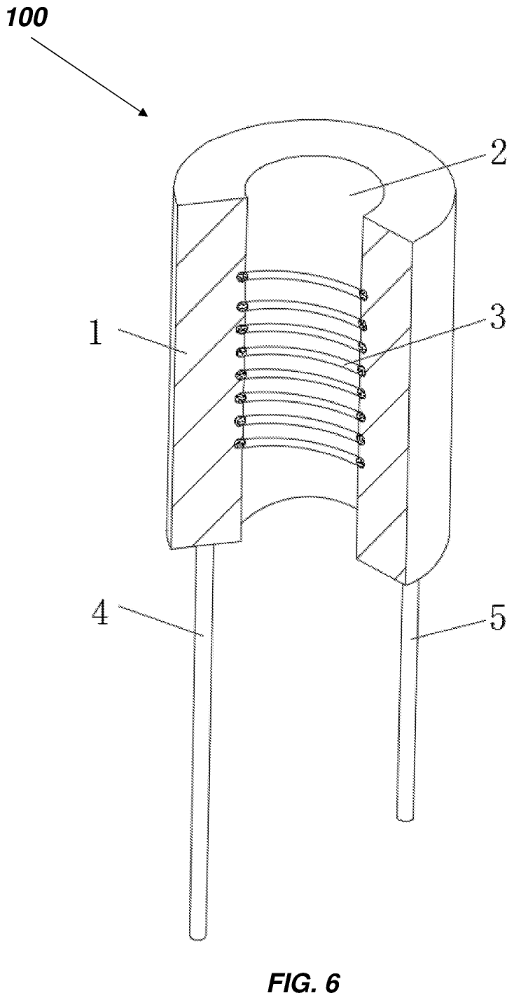

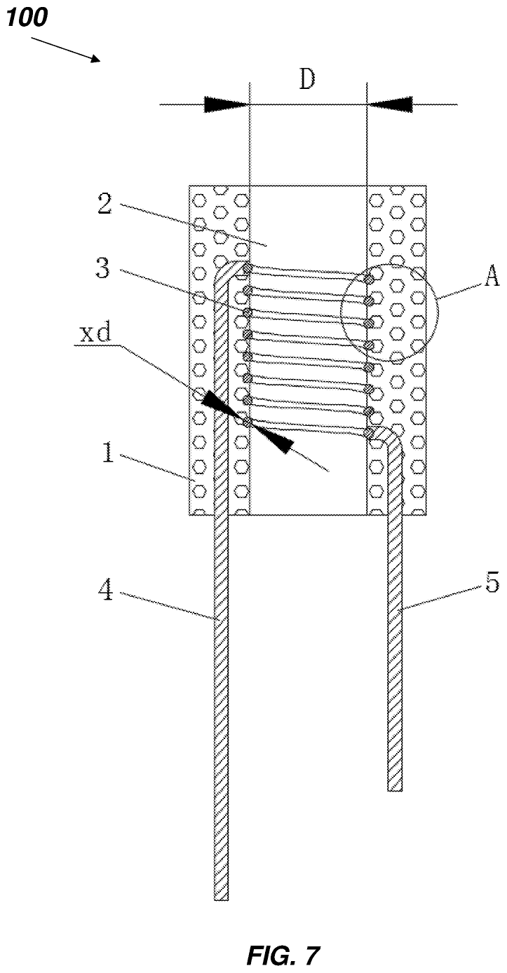

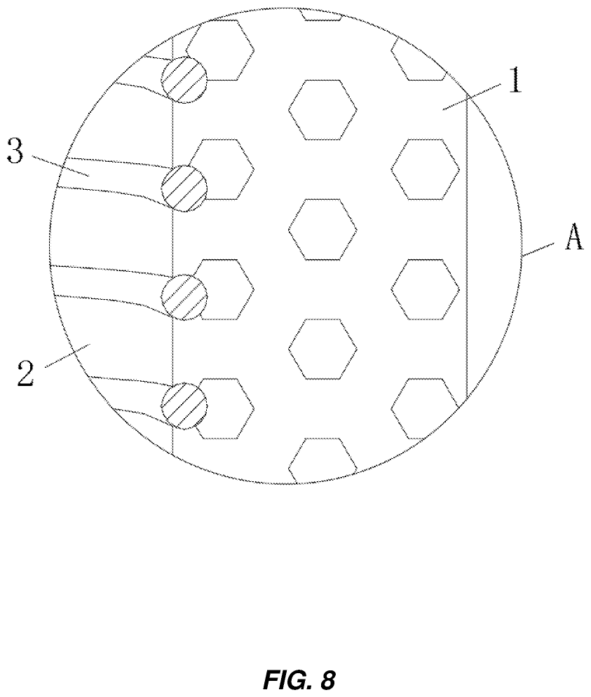

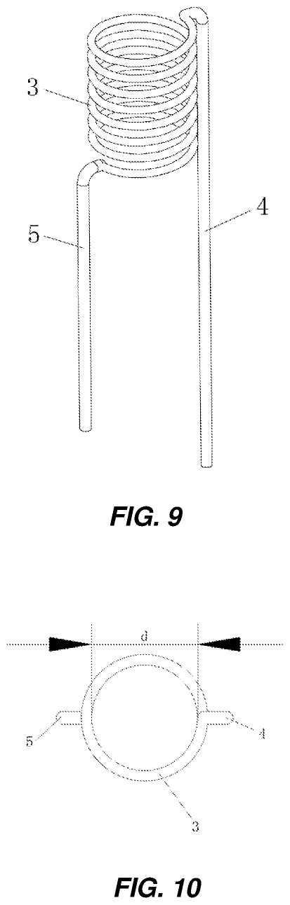

In some embodiments, one or more heating elements 100 inside the atomizer housing 24 provide heat to vaporize oil from the tank 15. With reference to FIGS. 5-10, the heating element 100 comprises a ceramic core 1 having a hollow interior 2. A coil 3 is embedded into the ceramic core 1. The ceramic core 1 has a with a first, inner diameter (indicated as D in FIG. 7) and the coil 3 has a second diameter (indicated as d in FIG. 10). In some configurations, at least a portion of the second diameter d of the coil 3 is smaller than the first, inner diameter D of the ceramic core 1 to expose at least a portion of the coil 3 to the hollow interior 2 of the ceramic core 1.

In some configurations, the coil 3 is inlaid and fixed on the inner wall of the hollow interior 2 of the ceramic core 1. One end of the coil 3 may be in communication with a first pin 4, or anode pin 4. The anode pin 4 may be at least partially embedded in the ceramic core 1. The other end of the coil 3 may be in communication with a second pin 4, or cathode pin 5. The cathode pin 5 may be at least partially embedded in the ceramic core 1.

In some embodiments, the appearance of the coil 3 is in the shape of a spring, but other shapes are contemplated and may be used. For example, the coil 3 may be conical, helical, triangular, etc., depending on the desired heating properties for the coil 3. In general, portions of the coil 3 that are closer to the oil held in the hollow interior 2 of the ceramic core 1, will provide a greater amount of heat to the oil compared to portions of the coil 3 that are farther from the hollow interior 2. Portions of the coil 3 that are exposed to the hollow interior 2 may directly contact the oil. Portions of the coil 3 that are embedded in the ceramic core 1 heat the oil indirectly through heating the ceramic core 1.

Within the ceramic core 1, portions of the coil 3 that are embedded closer to the hollow interior 2 may provide greater heating to the oil compared to portions of the coil 3 that are embedded farther from the hollow interior 2. Additionally, a coil may tend to heat more quickly near a center compared to the ends of the coil. All of these variables can be manipulated to achieve the desired heating effects for the heating element 100.

Depending on the desired heating effects, the coil 3 may be provided in different shapes and configurations to achieve the desired heating effects. The desired heating effects can be determined, for example, by the type of oil being vaped, user preference for cloud, user preference for vaping temperature, user preference for throat hit, user preference for flavor, etc. Depending on the configuration of the coil 3, a lower resistance coil may be used.

With reference to FIGS. 7-10, one embodiment is shown with the inner diameter of the coil 3 as d, the inner diameter of the hollow interior 2 of the ceramic core 1 as D, with the inner diameter of the coil d as smaller than the inner diameter D of the hollow interior 2 of the ceramic core 1. The wire diameter of the coil 3 is shown as xd, with xd cutting D, so that part of the coil 3 is exposed outside the inner diameter D of the hollow interior 2. This may improve the atomization effect in some embodiments.

In this configuration, the coil 3, the first pin 4 and the second pin 5 are an integral structure and are inlaid in the ceramic core 1, the coil 3 and the hollow interior 2 are on the same axis, and part of the coil 3 is exposed inside the hollow interior 2 to achieve a better atomization effect.

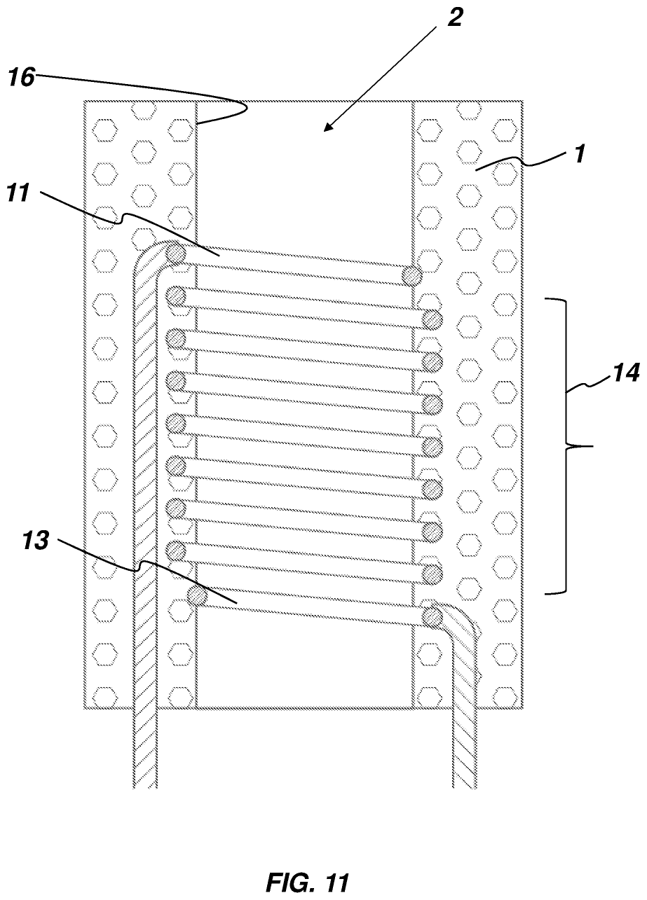

FIG. 11 illustrates another configuration of a heating element with a proximal portion 11 (such as a proximal winding) of the coil 3 and a distal portion 13 of the coil 3 at least partially exposed to the hollow interior 2 of the ceramic core 1. The medial portion 14 of the coil 3 is embedded in the ceramic core 1. This configuration may provide a more even temperature at or proximal to an interior edge 16 of the hollow interior 2 of the ceramic core 1, particularly for coils 3 that tend to heat more quickly near a center of the coil 3. The coil 3 may generally comprise one or more windings, and in some configurations the coil 3 comprises a proximal winding 11, a distal winding 13, and one or more medial portions or medial windings 14. The proximal portion 11 may include one or more windings, or may be less than a full winding. Similarly, the distal portion 13 may include one or more windings, or may be less than a full winding.

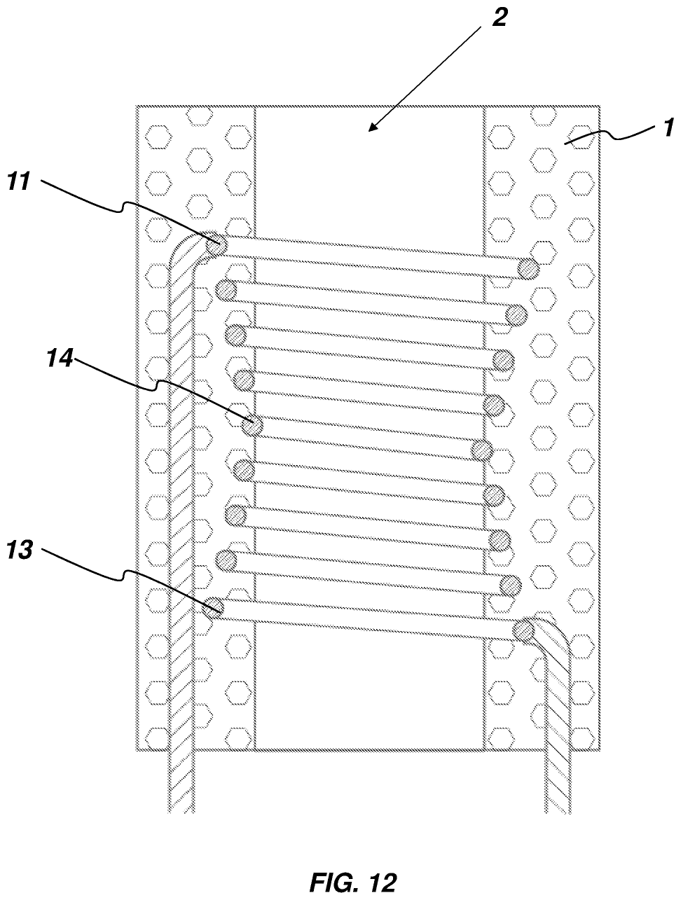

FIG. 12 illustrates another embodiment of a heating element with a proximal portion 11 of the coil 3 and a distal portion 13 of the coil 3 embedded in the ceramic core 1. A medial portion 14 of the coil 3 is at least partially exposed to the hollow interior 2 of the ceramic core 1. The inner diameter of each winding of the coil may have a different value, that is, the coil can have larger and smaller windings. In the configuration illustrated in FIG. 12, the smallest winding, or the winding with the smallest inner diameter, is near the medial or middle portion of the coil, and is the only winding that is at least partially exposed to the hollow interior 2 of the ceramic core 1.

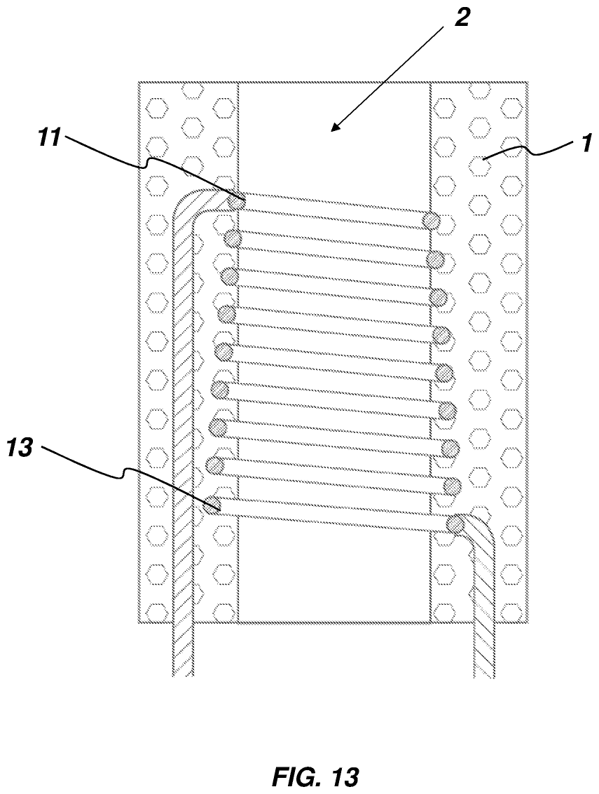

FIG. 13 illustrates another embodiment of a heating element with a proximal portion 11 of the coil 3 at least partially exposed to the hollow interior 2 of the ceramic core 1. In this configuration, as the coil 3 extends from the proximal portion 11 to the distal portion 13, the coil 3 becomes embedded farther into the ceramic core 1. In other words, the inner diameter of the coil increases as the coil extends from the proximal portion 11 to the distal portion 13. Each successive winding may have a slightly larger diameter, such that the coil has a generally frustoconical shape.

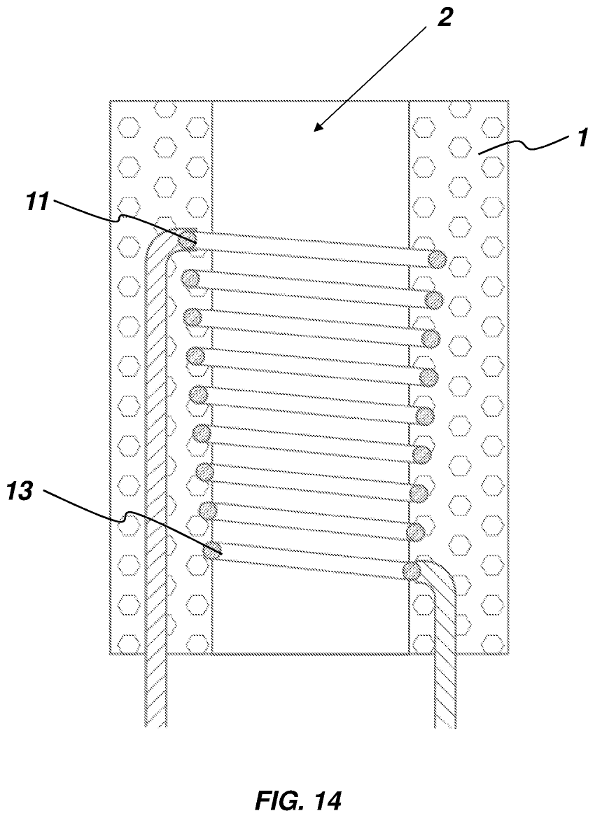

FIG. 14 illustrates another embodiment of a heating element with a distal portion 13 of the coil 3 at least partially exposed to the hollow interior 2 of the ceramic core 1. In this configuration, as the coil 3 extends from the proximal portion 11 to the distal portion 13, the coil becomes less embedded into the ceramic core 1. The coil 3 may have an inverted frustoconical shape, being wider at the proximal portion 11 and tapering toward distal portion 13. Other shapes and sizes of the coil are contemplated herein.

It should be noted that the relational terms herein such as first and second are only used to distinguish one entity or operation from another entity or operation and do not necessarily require or imply any such actual relation or sequence among these entities or operations. Furthermore, the terms “comprise,” “include” and any other equivalent expressions are intended to cover non-exclusive inclusion so that a process, method, object or device comprising a series of factors not only includes these factors but also includes other factors not expressly listed, or also includes factors inherent with the process, method, object or device.

Lastly, it should be noted that the foregoing description is only a preferred embodiment of the present utility model and is not intended to limit the present utility model. Although the present utility model has been elaborated by referring to the foregoing embodiments, those skilled in the art still can modify the technical solutions of the foregoing embodiments, or equivalently replace some or all of the technical features therein. All modification, equivalent replacements and improvements within the spirit and principle of the present utility model shall be in the scope of protection of the present utility model.

The relational terms herein such as first and second are only used to distinguish one entity or operation from another entity or operation and do not necessarily require or imply any such actual relation or sequence among these entities or operations. Furthermore, the terms “comprise,” “include” and any other equivalent expressions are intended to cover non-exclusive inclusion so that a process, method, object or device comprising a series of factors not only includes these factors but also includes other factors not expressly listed, or also includes factors inherent with the process, method, object or device. Lastly, the foregoing description only describes a few embodiments of the present utility model and is not intended to limit the present utility model. Although the present utility model has been elaborated by referring to the foregoing embodiments, those skilled in the art still can modify the technical solutions of the foregoing embodiments, or equivalently replace some or all of the technical features therein. All modification, equivalent replacements and improvements within the spirit and principle of the present utility model shall be in the scope of protection of the present utility model.

The description is only exemplary of the principles of the disclosure, and should not be viewed as narrowing the scope of the claims which follow, which claims define the full scope of the invention. Various aspects discussed in one drawing may be present and/or used in conjunction with the embodiment shown in another drawing, and each element shown in multiple drawings may be discussed only once. The described features, structures, or characteristics of configurations of the disclosure may be combined in any suitable manner in one or more configurations. In some cases, detailed description of well-known items or repeated description of substantially the same configurations may be omitted to facilitate the understanding of those skilled in the art by avoiding an unnecessarily redundant description. All statements herein reciting principles, aspects, and embodiments of the invention, as well as specific examples thereof, are intended to encompass equivalents thereof.

Reference in the specification to “one configuration” “one embodiment,” “a configuration” “an example,” or “an embodiment” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” or “in one example” in various places may not necessarily limit the inclusion of a particular element of the disclosure to a single configuration, rather the element may be included in other or all configurations discussed herein.

As used in this specification and the appended claims, singular forms such as “a,” “an,” and “the” may include the plural unless the context clearly dictates otherwise. Thus, for example, reference to “a winding” may include one or more of such windings, and reference to “the coil” may include reference to one or more of such coils.

As used herein, the term “generally” refers to something that is more of the designated adjective than not, or the converse if used in the negative. As used herein, the term “about” is used to provide flexibility to a numerical range endpoint by providing that a given value may be “a little above” or “a little below” the endpoint while still accomplishing the function associated with the range, for example, “about” may be within 10% of the given number or given range. As used herein, a plurality of items, structural elements, compositional elements, and/or materials may be presented in a common list for convenience. However, these lists should be construed as though each member of the list is individually identified as a separate and unique member.

While methods are described herein in discrete steps in a particular order for the sake of clarity, the steps do not require a particular order and more than one step may be performed at the same time. For example, a later step may begin before earlier step completes. Or, a later step may be completed before an earlier step is started. Additionally, the word “connected” and “coupled” is used throughout for clarity of the description and can include either a direct connection or an indirect connection.

Aspect 1: A vaping system comprising:

a tank with a reservoir for holding a liquid to be vaporized, the tank having a proximal end for connection to a mouthpiece and a distal end for connection to a cartridge base;

an atomizer housing within the tank, the atomizer housing comprising a distal base portion for receiving the liquid to be vaporized, a heating element, and a central lumen for a vapor to be drawn proximally, the central lumen extending from a distal end to a proximal end;

a mouthpiece having an external wall and an interior guide lumen for receiving vapor from the proximal end of the central lumen; and

wherein the heating element comprises a ceramic core having a hollow interior with a first, inner diameter and a coil embedded in the ceramic core, the coil having a second diameter, and wherein at least a portion of the second diameter is smaller than the first, inner diameter of the ceramic core to expose the coil to the hollow interior of the ceramic core.

Aspect 2: A heating element for a vaping device, the heating element comprising: a ceramic core having a hollow interior with a first, inner diameter;
a coil embedded in the ceramic core, the coil having a second diameter, and wherein at least a portion of the second diameter is smaller than the first, inner diameter of the ceramic core to expose at least a portion of the coil to the hollow interior of the ceramic core.

Aspect 3: The heating element for a vaping system of Aspect 2, wherein the coil comprises a proximal winding, a distal winding, and a plurality of medial windings between the proximal winding and the distal winding.

Aspect 4: The heating element for a vaping system of Aspect 2 or Aspect 3, wherein the proximal winding is at least partially exposed to the hollow interior of the ceramic core.

Aspect 5: The heating element for a vaping device of Aspect 3 or Aspect 4, wherein the distal winding is embedded in the ceramic core.

Aspect 6: The heating element for a vaping device of any one of Aspects 3-5, wherein the distal winding is at least partially exposed to the hollow interior of the ceramic core and the proximal winding is embedded in the ceramic core.

Aspect 7: The heating element for a vaping device of any one of Aspects 3-6, wherein the coil has a generally frustoconical shape.

Aspect 8: A ceramic heating core for a vaping device atomizer, comprising a ceramic core, a hollow interior, a coil, a first pin and a second pin, wherein the hollow interior is opened inside the ceramic core, and the coil being inlaid and fixed on an inner wall of the hollow interior.

Aspect 9: The ceramic heating core for a vaping device atomizer according to Aspect 8, wherein one end of the coil is fixedly connected to the first pin, and the first pin being inlaid inside the ceramic core.

Aspect 10: The ceramic heating core for a vaping device atomizer according to Aspect 8, wherein the other end of the coil is fixedly connected to the second pin, and the second pin being inlaid inside the ceramic core.

Aspect 11: The ceramic heating core for a vaping device atomizer according to Aspect 8, wherein the coil is in the shape of a spring.

Aspect 12: The ceramic heating core for a vaping device atomizer according to Aspect 8, wherein an inner diameter of the coil is d, an inner diameter of the hollow interior being D, d being smaller than D, a wire diameter of the coil being xd, and xd cutting D.

Although the foregoing disclosure provides many specifics, such as use of the system in vaping devices, it will be appreciated that other implementations are contemplated and these should not be construed as limiting the scope of any of the ensuing claims. Other embodiments and configurations may be devised which do not depart from the scopes of the claims. Features from different embodiments and configurations may be employed separately or in combination. Accordingly, all additions, deletions and modifications to the disclosed subject matter that fall within the scopes of the claims are to be embraced thereby. The scope of each claim is indicated and limited only by its plain language and the full scope of available legal equivalents to its elements.

Furthermore, if any references have been made to patents and printed publications throughout this disclosure, each of these references and printed publications are individually incorporated herein by reference in their entirety.

1. A vaping system comprising:
a tank with a reservoir for holding a liquid to be vaporized, the tank having a proximal end for connection to a mouthpiece and a distal end for connection to a cartridge base;
an atomizer housing within the tank, the atomizer housing comprising a distal base portion for receiving the liquid to be vaporized, a heating element, and a central lumen for a vapor to be drawn proximally, the central lumen extending from a distal end to a proximal end;
the mouthpiece having an external wall and an interior guide lumen for receiving vapor from the proximal end of the central lumen; and
wherein the heating element comprises a ceramic core having a hollow interior with a first, inner diameter and a coil embedded in the ceramic core, the coil having a second diameter, and wherein at least a portion of the second diameter is smaller than the first, inner diameter of the ceramic core to expose the coil to the hollow interior of the ceramic core.

2. A heating element for a vaping device, the heating element comprising:
a ceramic core having a hollow interior with a first, inner diameter;
a coil embedded in the ceramic core, the coil having a second diameter, and wherein at least a portion of the second diameter is smaller than the first, inner diameter of the ceramic core to expose the at least a portion of the coil to the hollow interior of the ceramic core.

3. The heating element for a vaping device of claim 2, wherein the coil comprises a proximal winding, a distal winding, and a plurality of medial windings between the proximal winding and the distal winding.

4. The heating element for a vaping device of claim 3, wherein the proximal winding is at least partially exposed to the hollow interior of the ceramic core.

5. The heating element for a vaping device of claim 4, wherein the distal winding is embedded in the ceramic core.

6. The heating element for a vaping device of claim 3, wherein the distal winding is at least partially exposed to the hollow interior of the ceramic core and the proximal winding is embedded in the ceramic core.

7. The heating element for a vaping device of claim 3, wherein the coil has a generally frustoconical shape.

8. A ceramic heating core for a vaping device atomizer, comprising a ceramic core, a hollow interior, a coil, a first pin and a second pin, wherein the hollow interior is opened inside the ceramic core, and the coil being inlaid and fixed on an inner wall of the hollow interior.

9. The ceramic heating core for a vaping device atomizer according to claim 8, wherein a first end of the coil is fixedly connected to the first pin, and the first pin being inlaid inside the ceramic core.

10. The ceramic heating core for a vaping device atomizer according to claim 8, wherein the second end of the coil is fixedly connected to the second pin, and the second pin being inlaid inside the ceramic core.

11. The ceramic heating core for a vaping device atomizer according to claim 8, wherein the coil is in a shape of a spring.

12. The ceramic heating core for a vaping device atomizer according to claim 8, wherein an inner diameter of the coil is d, an inner diameter of the hollow interior being D, d being smaller than D, a wire diameter of the coil being xd, and xd cutting D.
